(19) United States
(12) Patent Application Publication
(10) Pub. No.: US 2009/0177488 A1
(43) Pub. Date: Jul. 9, 2009

(54) SYSTEM AND METHOD FOR ADJUDICATION AND SETTLEMENT OF HEALTH CARE CLAIMS

(75) Inventors: Judith UNLAND, Elmhurst, IL (US); Mike KNAUFF, Libertyville, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: DISCOVER FINANCIAL SERVICES LLC, Riverwoods, IL (US)

(21) Appl. No.: 11/971,717

(22) Filed: Jan. 9, 2008

(51) Int. Cl. G06Q 50/00; G06Q 40/00

(52) U.S. Cl. 705/2; 705/40

(57) ABSTRACT

Systems and methods are disclosed for settling health care claims as part of a claim adjudication process. A standard financial transaction network is used to settle the portion of the claim not covered by insurance. Eligibility checks are also disclosed that make use of the financial transaction network to determine whether a patient has sufficient funds in a financial account to cover his portion of health care related expenses. The eligibility checks can be combined with the settlement process.

### FIELD OF THE INVENTION

This invention pertains generally to the field of health care insurance claim processing and more particularly to the settlement of health care insurance claims.

### BACKGROUND

Traditional methods for settlement of health care transactions can be a lengthy process. Typically, after providing services to a patient, a health care provider submits a claim to a health plan organization (such as a health insurance carrier) with whom the provider has previously entered a contractual relationship. The health plan organization or their agent adjudicates the claim to determine an amount of funds for which the provider is to be compensated by the carrier, and an amount for which the provider is to be compensated by the patient. The provider is compensated by the carrier and both the patient and provider are supplied a breakdown of the adjudicated claim in the form of an “explanation of benefits” (EOB). The provider in turn typically bills the patient his portion according to the EOB. The delays inherent in the traditional methods can jeopardize a provider's ability to collect owed funds from the patient.

Additionally, with a greater number of consumers becoming responsible for larger portions of their health care expenses through high deductible health plans, providers bear increasing risks that patients may not be able to pay their portions.

### BRIEF SUMMARY OF THE INVENTION

Ways are provided for allowing complete settlement of health care related transactions within the context of the adjudication process. A health plan organization, upon adjudicating a claim from a provider, returns financial information and EOB information to a clearinghouse. The clearinghouse sends the financial information, without any EOB or medical information, to an operator on a standard financial transaction network, such as a payments card network. A processor for the card issuer identifies the patient and matches it to a corresponding financial account (e.g., the patient's payment card account). The payments card network operator sends a message to the issuer that causes appropriate settlement funds to be transferred from the patient's account to an account of the provider. In this manner, providers are guaranteed of payment by their patients without delay or extra billing for eligible services. Patients no longer need to receive bills from their providers for eligible services. Additionally, the network operators avoid possession of personally identifiable health information that might subject them to governmental regulations, such as the Health Insurance Portability and Accountability Act (HIPAA).

Moreover, the settlement process can be combined with an eligibility check via the standard financial transaction network. In this way, funds can be held for payment in the event it is later discovered that the provided services are not eligible for coverage under the health plan or are eligible but not covered fully.

In one aspect, a method is provided for settling funds associated with the purchase of health related products or services of a health care provider by a health plan member, the health plan administered by a health plan organization, comprising transmitting a request for payment from the health plan organization, the request comprising information identifying the health plan member and the health related products or services receiving, in response to the request, adjudication information comprising financial transaction data and explanatory data, the financial transaction data comprising a first amount of funds for payment by the health plan organization and a second amount of funds for payment by the health plan member, and forwarding the financial transaction data to an entity on a financial transaction payment network for payment of the second amount of funds to the health care provider.

In another aspect, a system is provided for facilitating the settlement of funds associated with the purchase of health related products or services of a health care provider by a health plan member, the health plan administered by a health plan organization, comprising a first message comprising a request for payment for the purchase of the health related products or services, a first transaction network for transmitting, between the health care provider and the health plan organization, the first message, a second message, responding to the first message, comprising financial transaction data and explanatory data, the financial transaction data comprising a first amount of funds for payment by the health plan organization and a second amount of funds for payment by the health plan member, the second message for transmission over the first transaction network, a second transaction network for transmitting a request for a transfer of the second amount of funds from an issuer bank to the health care provider, the issuer bank corresponding to the health plan member, and a clearinghouse entity on the first transaction network for receiving the second message and for forwarding the financial transaction data to the second transaction network.

In still another aspect, a method is provided of settling funds corresponding to a transaction for the provision of health related services, the services performed by a health care provider for the benefit of a member of a health plan, the health plan administered by a health plan organization, the method comprising the steps of receiving, without additional input from the health care provider or the member, financial information corresponding to an adjudicated health care claim from a third party clearinghouse of health care claims, the financial information comprising a first amount due the health care provider for the provision of the services and which is not being paid by the health plan organization under the member's health plan, identifying, using the received financial information, the member and a financial account associated with the member, and causing funds to be transferred from a financial account associated with the member to an account associated with the health care provider.

In yet another aspect, a method is provided for being compensated for the provision of health related services to a health plan member, the health plan administered by a health plan organization, comprising submitting a request for payment, the request comprising information regarding the health plan member and the health related services provided, receiving, in response to the request, a first payment portion from the health plan organization, the first payment portion corresponding to a first amount as determined by the health plan organization pursuant to an adjudication, and receiving, in response to the request, a second payment portion via a financial transaction network, the second payment portion corresponding to a second amount as determined by the health plan organization, wherein the second payment portion is transmitted automatically without additional input from the health plan member.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 is a is a general overview of components in a health care insurance claim processing arrangement;

FIG. 2 is a general overview of the operation of a method and system contemplated by an embodiment of the present invention;

FIG. 3 is a flow diagram illustrating a method for adjudicating and settling health care claims using a standard financial transaction network, in accordance with an embodiment of the invention;

FIG. 4 is a flow diagram illustrating a method of determining the eligibility for payment of provided services via a standard transaction network, in accordance with an embodiment of the invention; and

FIG. 5 is a flow diagram illustrating a method of settling funds in a health care transaction, in accordance with an embodiment of the invention.

### DETAILED DESCRIPTION OF THE INVENTION

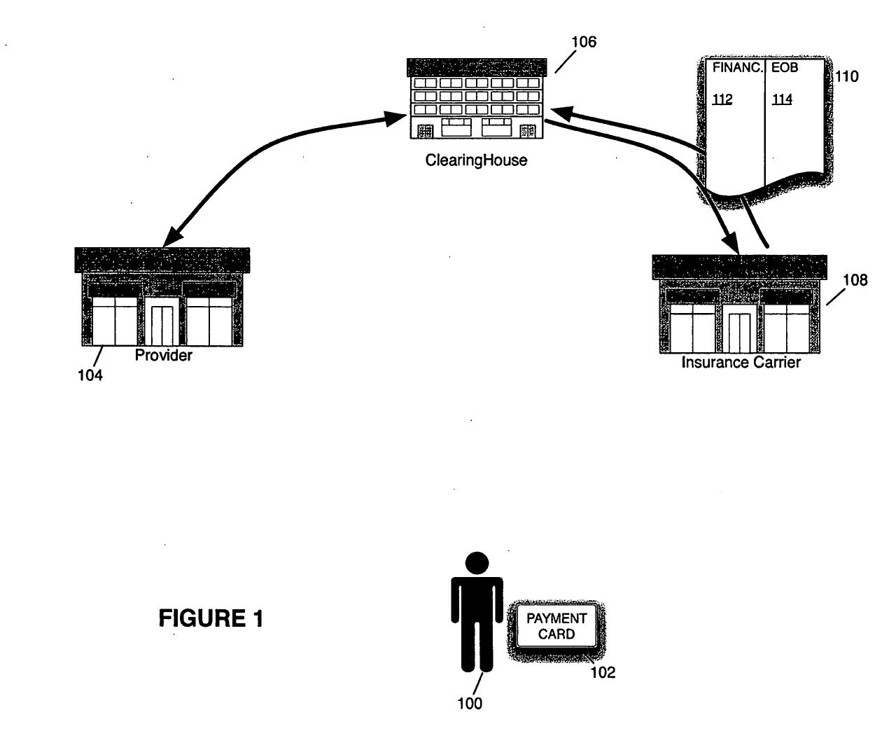

Turning to FIG. 1, a system is shown in which the settlement process typically occurs for health related claims, without the use of a financial transaction network. A patient 100 visits a health care provider 104 for health related services. The patient 100 possesses a card 102 which identifies a health plan under which the patient 100 is entitled to benefits. The provider 104 obtains information from the card 102, either by photocopying the card or using a card reader and, after the provision of services, submits the card 102 information along with information regarding the services provided to a clearinghouse 106 for processing. This is usually done in the form of an “837” claim request.

The clearinghouse 106 receives the 837 request and forwards it to the sponsoring health plan organization identified on the patient's card 102. The health plan organization (HPO) 108 (generally an insurance carrier) or their agent adjudicates the claim to determine a total amount to be charged for the provided services according to the patient's plan and the provider's contract, and to determine the portion of that amount that the health plan organization will compensate the provider. If the HPO 108 determines the services are not eligible for coverage under the patient's plan, it can deny the claim altogether. The health plan organization 108 pays the portion it owes, typically via check, to the provider and returns an “835” response 110 to the clearinghouse 106. The 835 response includes two components: a financial component 112 and an explanation of benefits (“EOB”) 114. The clearinghouse 106 forwards the 835 response 110 to the provider 104, who then has responsibility for collecting any remaining portion owed from the patient 100 The health plan organization 108 typically sends the EOB 114 directly to the patient 100 as well, for informational purposes.

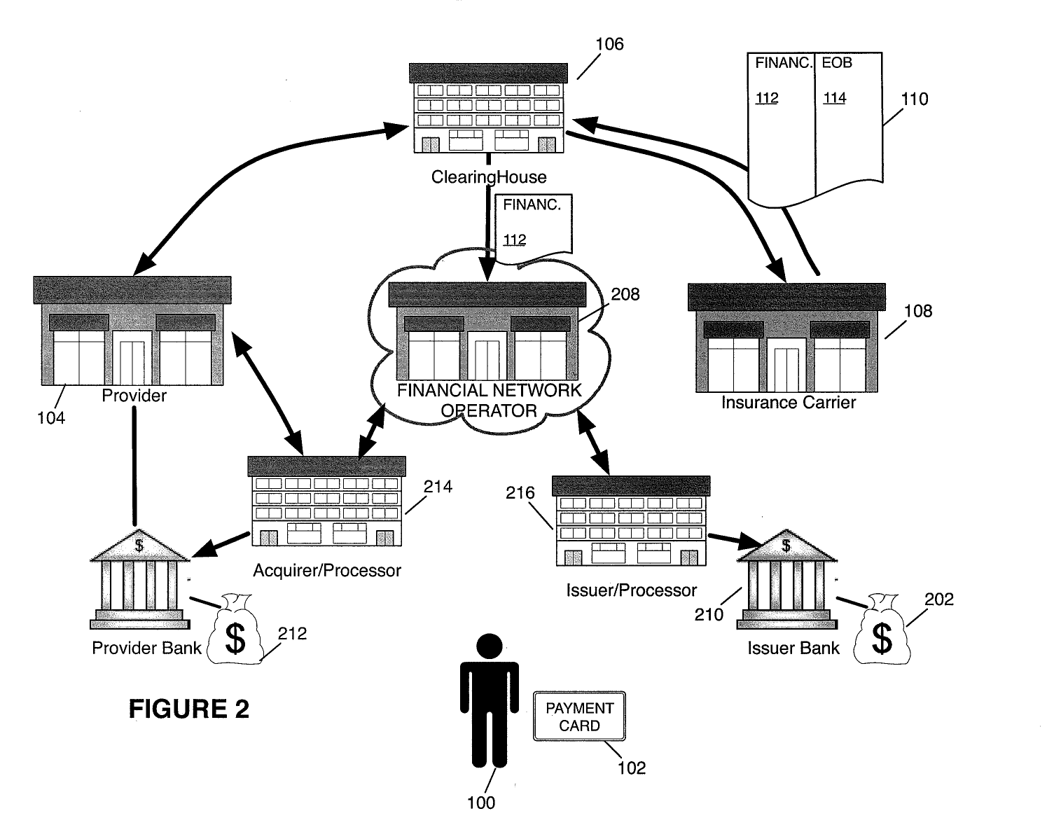

By incorporating a standard financial processing network into the settlement and adjudication process, additional benefits are gained. An exemplary system of such an incorporation of a standard financial processing network is now described with reference to FIG. 2. As in the typical case, the patient 100 presents a health card 102 to a health care provider 104 at the time services are to be rendered. The card 102 is associated with the patient's health plan organization 108, but is also preferably associated with a financial account 202 of the patient. The financial account 202 is typically a tax-advantaged account, such as a flexible spending account (FSA), health reimbursement arrangement (HRA) and health savings account (HSA), or alternatively is a non-tax-advantaged financial account, such as a checking, savings, prepaid, debit or credit account.

The adjudication process begins similarly, with the provider 104 submitting a claim via an 837 request to the clearinghouse 106, and the clearinghouse 106 forwarding the request to the HPO 108. The HPO 108 adjudicates the claim, sends appropriate payment to the provider 104, and sends the 835 response back to the clearinghouse 106. The clearinghouse 106, however, extracts the financial portion 112 of the 835 response and transmits it to a payments network operator 208 on a standard financial transaction network, such as the DISCOVER NETWORK. The clearinghouse 106 reformats the financial information, if necessary, in order that it conforms to requirements of the financial network. The network operator 208, typically working in conjunction with an issuer/processor 216, then causes funds to be debited from the account 202 associated with the patient 100 and maintained by an issuer bank 210 (i.e., the issuer of the patient's card 102), and added to an account 212 associated with the provider 104. This transfer of funds is performed similarly to a routine financial transaction over the network, such as through the use of an acquirer/processor 214 and issuer/processor 216 to interface directly with the provider's bank and the issuer's bank.

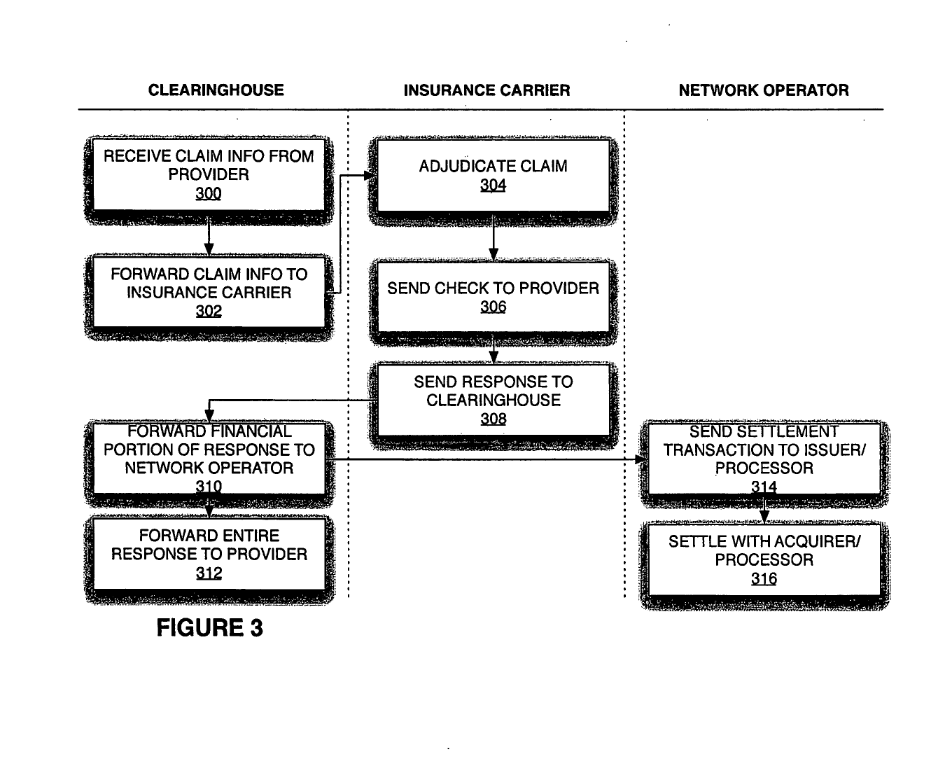

In greater detail, a technique for settling health care transactions, as used in an embodiment of the invention, is now described with respect to FIG. 3. A clearinghouse facilitates communications between a health care provider and an insurance carrier or other health plan organization (HPO). The clearinghouse receives claim information from the provider at step 300. Preferably, the provider has transmitted the claim information in a suitable format, such as an 837 request, either contemporaneously with or subsequent to provision of services to a patient. The claim information preferably contains patient identifying information, health plan information, codified description of services provided, and other information. The clearinghouse then forwards the request to the HPO at step 302, reformatting the request if necessary for compatibility with HPO guidelines.

After receiving the forwarded claim information from the clearinghouse, at step 304 the HPO or their agent adjudicates the claim. The adjudication takes into account several factors in order to determine an amount to be charged. Preferably, these factors include the patient's health plan, history (e.g., whether deductibles have been met, whether maximum limits have been reached, etc.), description of services provided, and diagnosis information. The result of the adjudication is a total charge for the provided services, along with a breakdown of a first portion to be paid by the health plan (i.e., insurance) and a second portion to be paid by the patient. The HPO transmits funds to the provider at step 306, either by mailing a check or through an electronic transaction such as via ACH. The HPO responds to the clearinghouse request, typically with an “835 response”, at step 308. The response contains a financial component (e.g., an amount the provider should obtain from the patient and the amount the provider will obtain from the HPO) and a description component (e.g., an Explanation of Benefits (EOB)). Additionally, in some embodiments the HPO sends an EOB to the patient directly.

Upon receiving the response from the HPO, the clearinghouse forwards the financial portion to the operator of a standard financial transaction network at step 310. If necessary, the clearinghouse reformats the information for compatibility with financial transaction network. The clearinghouse additionally forwards the entire response to the provider at step 312 for record keeping.

The network operator, after receiving the financial portion of the response from the clearinghouse, facilitates settlement by sending a request for funds at step 314 to an issuer/processor or batik issuing the patient's payment card. Preferably, the request for funds was previously authorized by the issuer bank, in a manner such as that described below. The network operator then causes the funds to be transmitted to the provider's bank via an acquirer/processor at step 316. Because the network operator has not received any personally identifiable health information of the patient, it is exempt from regulatory requirements that would otherwise affect it, such as HIPAA.

In order to ascertain that sufficient funds are available via insurance and the patient's FSA, HRA, HSA or other financial accounts, embodiments of the invention advantageously make use of a standard financial transaction network to combine an insurance eligibility check with a financial check. In this way, the provider can be guaranteed full payment—via the insurance carrier and the patient's financial account—for the total charge for the services. At the time services are to be performed by the provider, information from the patient's payment card is used to send an authorization request. The request is sent to the standard financial transaction network operator who sends it to the issuer/processor for an eligibility check. In performing the check, two variables are examined: whether the patient has health insurance, and whether there are sufficient funds in the patient's financial account. The check is preferably performed via an authorization request over the financial transaction network. The check may be based on identifying information stored on the card, such as a cardholder identification number, that can be used to determine whether the patient has health insurance, and/or if the card is linked to a tax-advantaged healthcare account such as a FSA, HRA or HSA. The issuer/processor may have knowledge of who is and is not covered under an insurance plan based on information provided by the cardholder's employer. If the request is approved, this allows a “hold” to be placed on the patient's account, thereby ensuring those funds are available for transfer to the provider. Later, when adjudication of the claim is performed, an appropriate amount of funds is transferred pursuant to the authorization.

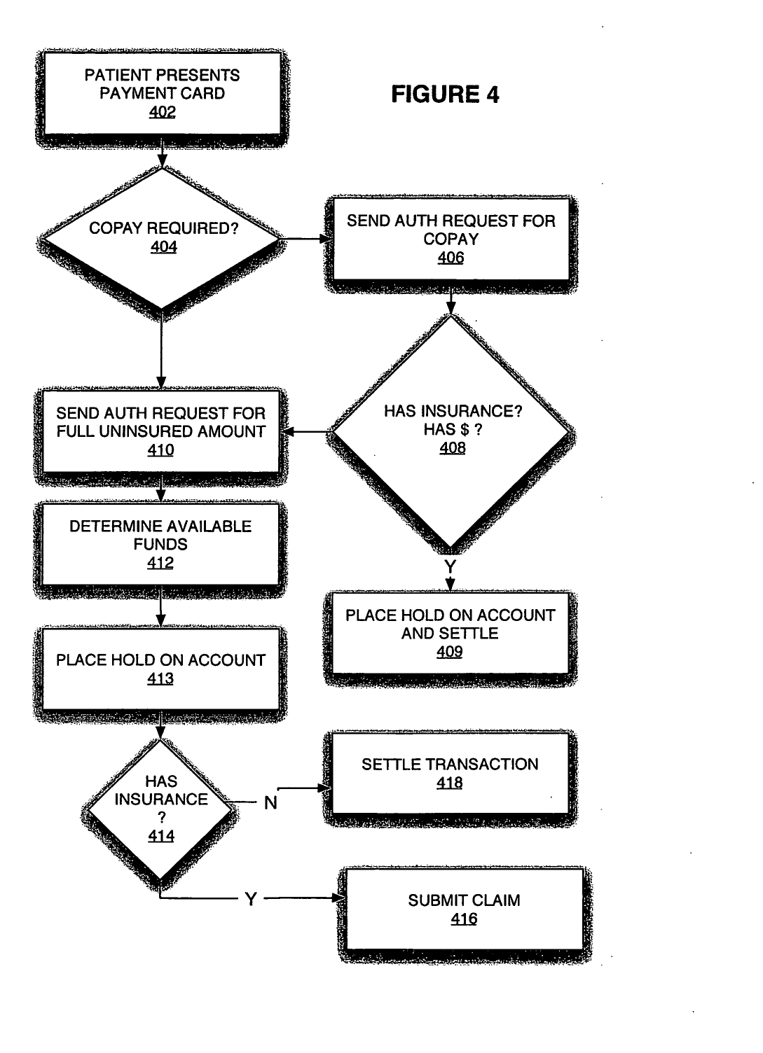

In greater detail, a method is described for performing a financial eligibility check with respect to FIG. 4, as executed in an embodiment of the invention. At the time services are to be provided, the patient presents his payment card to the provider at step 402. For many services, such as routine office visitations, the copay required of the patient under the terms of the health plan may be known to the provider. The provider determines if the required copay is known at step 404, typically by inspecting the card visually for an indication of a co-pay amount, and, if so, sends an authorization request over a financial transaction network for the amount of the copay at step 406. In response to the request, checks are performed by the issuer/processor at step 408 to determine whether the patient has insurance to cover the services and whether there are sufficient funds in the patients account to cover payment of the copay. The checks may be based on identifying information stored on the card, such as a cardholder identification number, that can be used to determine whether the patient has health insurance, and/or if the card is linked to a tax-advantaged healthcare account such as a FSA, HSA or HRA. If the services are covered and there are sufficient funds, a hold is placed on the account in the amount of the copay at step 409 and the transaction settles in the normal course, typically via a nightly batch process.

If the copay is not known, or if it is known that the patient is a member of a high deductible health plan, then the provider sends an authorization request at step 410 for the full amount of the services, i.e., the amount that would be charged to an uninsured patient. In response to the request, a check is performed at step 412 to determine the extent to which funds are available in the patient's account to cover an estimated charge, and this information is conveyed to the provider. A hold is placed on the patient's account at step 413 to the extent funds are available for the services to be provided. An additional or included check is performed at step 414 to determine whether the patient is insured. The check may be based on identifying information stored on the card, such as a cardholder identification number, that can be used to determine whether the patient has health insurance. If the patient is insured, the provider submits a claim to the insurance carrier via a clearinghouse at step 416. The claim is preferably sent in a standard format, such as an 837 request. In some cases, the held amount may be less than the full amount charged by the provider for the services. For example, in some embodiments, the held amount is determined based on whether the provider has contracted with the insurance carrier to provide discounted services. Such a determination can be made, for example, based on a merchant code that is transmitted with the authorization request. The amount held can then, for example, be determined as a weighted average of amounts previously known to be charged for similar services and/or by similar providers and/or insured by similar insurance carriers.

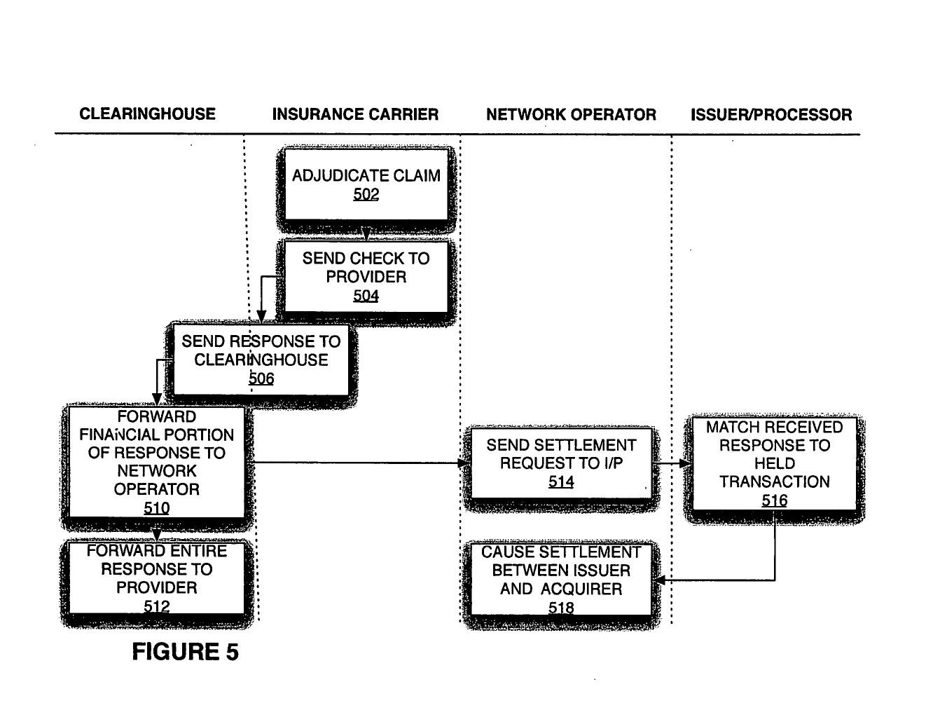

Turning to FIG. 5, in an embodiment of the invention, the held transaction does not settle immediately, but instead is placed in abeyance with the issuer/processor. In response to the 837 request, the insurance carrier adjudicates the claim at step 502 to determine the total charge for the services according to the provider's contract, and the portion to be paid by the patient according to the terms of the patient's health plan. The carrier may pay the provider the appropriate insured amount at step 504. At step 506, the insurance carrier sends this information back to the clearinghouse in the form of an 835 response comprising both financial information and an explanation of benefits. In a manner such as described above, the clearinghouse forwards the financial information to the network operator at step 510, and preferably forwards the entire response to the provider at step 512.

Upon receiving the financial information from the clearinghouse, the network operator sends a settlement request to the issuing processor at step 514. The issuing processor matches the financial information to the held authorized transaction at step 516 so that the amount of funds authorized in the held transaction is adjusted to reflect the actual charge, i.e., as discounted according to the insurance carrier's adjudication. In an embodiment of the invention, the matching is based on a variety of matching criteria, such as time/date of service, actual amount being within a percentage threshold of the original authorized amount, name of provider, network trace numbers, or other transaction identifying information. The network operator causes at step 518 the settlement of funds between the issuer bank and the provider's bank as it normally would.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for settling funds associated with the purchase of health related products or services of a health care provider by a health plan member, the health plan administered by a health plan organization, comprising:
transmitting a request for payment from the health plan organization, the request comprising information identifying the health plan member and the health related products or services;
receiving, in response to the request, adjudication information comprising financial transaction data and explanatory data, the financial transaction data comprising a first amount of funds for payment by the health plan organization and a second amount of funds for payment by the health plan member; and
forwarding the financial transaction data to an entity on a financial transaction payment network for payment of the second amount of funds to the health care provider.

2. The method of claim 1 wherein the financial data forwarded to the entity on the financial payment network is free of information regarding the purchased health related products or services.

3. The method of claim 1 further comprising forwarding the financial transaction data and explanatory data to the health care provider.

4. The method of claim 1 wherein the explanatory data is an explanation of the health plan member's benefits with respect to the purchase of the health related products or services under the health plan.

5. A system for facilitating the settlement of funds associated with the purchase of health related products or services of a health care provider by a health plan member, the health plan administered by a health plan organization, comprising:
a first message comprising a request for payment for the purchase of the health related products or services;
a first transaction network for transmitting, between the health care provider and the health plan organization, the first message;
a second message, responding to the first message, comprising financial transaction data and explanatory data, the financial transaction data comprising a first amount of funds for payment by the health plan organization and a second amount of funds for payment by the health plan member, the second message for transmission over the first transaction network;
a second transaction network for transmitting a request for a transfer of the second amount of funds from an issuer bank to the health care provider, the issuer bank corresponding to the health plan member; and
a clearinghouse entity on the first transaction network for receiving the second message and for forwarding the financial transaction data to the second transaction network.

6. The system of claim 5 wherein the financial data forwarded to the second transaction network is free of information regarding the identity of purchased health related products or services.

7. The system of claim 5 further comprising an operator entity on the second transaction network for receiving the forwarded financial transaction data and for causing the request for transfer of the second amount of funds from the issuer bank to the health care provider.

8. A method of being compensated for the provision of health related services to a health plan member, the health plan administered by a health plan organization, comprising:
submitting a request for payment, the request comprising information regarding the health plan member and the health related services provided;
receiving, in response to the request, a first payment portion from the health plan organization, the first payment portion corresponding to a first amount as determined by the health plan organization pursuant to an adjudication; and
receiving, in response to the request, a second payment portion via a financial transaction network, the second payment portion corresponding to a second amount as determined by the health plan organization;
wherein the second payment portion is transmitted automatically without additional input from the health plan member.

9. The method of claim 8 wherein the second payment portion is made from an account corresponding to the health plan member and accessible via the financial transaction network.

10. The method of claim 8 wherein the second payment portion is paid via the financial transaction network in response to a request made by a party other than the receiver of the first or second payment.

11. A method of settling funds corresponding to a transaction for the provision of health related services, the services performed by a health care provider for the benefit of a member of a health plan, the health plan administered by a health plan organization, the method comprising the steps of:
receiving, without additional input from the health care provider or the member, financial information corresponding to an adjudicated health care claim from a third party clearinghouse of health care claims, the financial information comprising a first amount due the health care provider for the provision of the services and which is not being paid by the health plan organization under the member's health plan;
identifying, using the received financial information, the member and a financial account associated with the member; and
causing funds to be transferred from a financial account associated with the member to an account associated with the health care provider.

12. The method of claim 11 wherein the amount of funds caused to be transferred is equal to the first amount due the health care provider.

13. The method of claim 11 further comprising:
receiving, substantially at the time the health related services are provided, an authorization request for funds in payment for the provision of the services;
approximating a second amount of funds for which the member will be responsible; and
placing a financial hold in the second amount on the financial account associated with the member.

14. The method of claim 13 further comprising:
determining, based on at least the first amount and the second amount, the amount of funds to be transferred from the financial account associated with the member to the account associated with the health care provider;
wherein the amount of funds to be transferred from the financial account is at least the lesser of the first amount and the second amount.

15. The method of claim 13 wherein approximating the second amount comprises:
determining that the member is a member of the health plan;
determining whether the provider participates in the health plan; and
computing a weighted average for amounts known to have been previously charged for health related services under the health plan.

16. The method of claim 11 further comprising:
receiving, substantially at the time the health related services are provided, an authorization request for funds in payment for the provision of the services; and
placing a financial hold on the financial account associated with the member for a fixed amount based on the services provided.
